(19) United States
(12) Patent Application Publication
(10) Pub. No.: US 2016/0221260 A1
(43) Pub. Date: Aug. 4, 2016

(54) AUTOMATIC EJECTOR HEAD DROP MASS ADJUSTMENT IN A THREE-DIMENSIONAL OBJECT PRINTER

(71) Applicant: Xerox Corporation, Norwalk, CT (US)

(72) Inventor: Christine A. Steurrys, Williamson, NY (US)

(21) Appl. No.: 14/612,627

(22) Filed: Feb. 3, 2015

(51) Int. Cl. B29C 67/00

(52) U.S. Cl. CPC B29C 67/0059; B33Y 10/00

(57) ABSTRACT

A three-dimensional object printer compensates for variations in material drop volumes between ejectors. The printer includes a scale that measures a weight of at least one of a platform and a substrate. A controller operates the scale to weigh the platform or the substrate before and after printing a test pattern to calculate a drop volume of at least one ejector. The controller calculates a relationship between drop mass and firing signal parameters for the at least one ejector based on the calculated first drop mass. The controller adjusts the firing signal parameters for the at least one ejector based on the calculated relationship between the drop mass of the at least one ejector and the firing signal parameters for the at least one ejector to compensate for variations in drop volumes between the at least one ejector and other ejectors in the at least one ejector head.

### TECHNICAL FIELD

The device disclosed in this document relates to printers that produce three-dimensional objects and, more particularly, to the accurate production of objects with such printers.

### BACKGROUND

Digital three-dimensional manufacturing, also known as digital additive manufacturing, is a process of making a three-dimensional solid object of virtually any shape from a digital model. Three-dimensional printing is an additive process in which one or more printheads or ejector heads eject successive layers of material on a substrate in different shapes. The substrate is supported either on a platform that can be moved three dimensionally by operation of actuators operatively connected to the platform, or the printhead or printheads are operatively connected to one or more actuators for controlled movement of the printhead or printheads to produce the layers that form the object. Three-dimensional printing is distinguishable from traditional object-forming techniques, which mostly rely on the removal of material from a work piece by a subtractive process, such as cutting or drilling.

The production of a three-dimensional object with these printers can require hours or, with some objects, even days. One issue that arises in the production of three-dimensional objects with a three-dimensional printer is consistent functionality of the ejectors in the printheads that eject the material drops that form the objects. During printing of an object, one or more ejectors can eject material with a drop volume that is slightly different from the drop volume of the ejectors surrounding the ejector. These volumetric differences can accumulate during the printing of the multiple layers that form an object so the column of material formed by the ejector ejecting the smaller or larger drops can be shorter or taller, respectively, than the surrounding material columns formed by the other ejectors. These surface variations can be significant enough to require the scrapping of the object. Because the print jobs can require many hours or multiple days to produce objects, this scrapping of objects can be expensive and time consuming. A three-dimensional object printer capable of compensating for the volumetric variations in material drops ejected by ejectors in such printers would be advantageous.

### SUMMARY

A three-dimensional object printer that detects volumetric drop variations in the ejectors during printing and adjusts the firing signal parameters used to operate the ejector heads to compensate for these variations has been developed. The three-dimensional object printer includes a track; a at least one ejector head disposed along the track, the at least one ejector head being configured to eject drops of a material onto a substrate; a platform configured to move along the track to convey the substrate to a position to enable the at least one ejector head to eject drops of the material onto the substrate; a scale configured to measure a weight of at least one of the platform and the substrate; and a controller operatively connected to the scale and the at least one ejector head, the controller being configured to: operate the scale to identify a first weight measurement of at least one of the platform and the substrate; operate the at least one ejector head with first firing signal parameters to eject material onto the at least one of the platform and the substrate; operate the scale to identify a second weight measurement of the least one of the platform and the substrate; calculate a first drop mass of at least one ejector in the at least one ejector head based on a difference between the first weight measurement and the second weight measurement; calculate a relationship between a drop mass of the at least one ejector and firing signal parameters for the at least one ejector based on the calculated first drop mass; and adjust the firing signal parameters for the at least one ejector based on the calculated relationship between the drop mass of the at least one ejector and the firing signal parameters for the at least one ejector to compensate for variations in drop volumes between the at least one ejector and other ejectors in the at least one ejector head.

A method has been developed for operating a three-dimensional object printer that detects volumetric drop variations in the ejectors during printing and adjusts the firing signal parameters used to operate the printheads in the printer to compensate for these variations. The method includes operating a scale to identify a first weight measurement of at least one of a platform and a substrate; operating an at least one ejector head with first firing signal parameters to eject material onto the at least one of the platform and the substrate; operating the scale to identify a second weight measurement of the least one of the platform and the substrate; calculating a first drop mass of at least one ejector in the at least one ejector head based on a difference between the first weight measurement and the second weight measurement; calculating a relationship between a drop mass of the at least one ejector and firing signal parameters for the at least one ejector based on the calculated first drop mass; and adjusting the firing signal parameters for the at least one ejector based the calculated relationship between the drop mass of the at least one ejector and the firing signal parameters for the at least one ejector to compensate for variations in drop volumes between the at least one ejector and other ejectors in the at least one ejector head.

### BRIEF DESCRIPTION OF THE DRAWINGS

The foregoing aspects and other features of an apparatus and method that detects volumetric drop variations in the ejectors during printing and adjusts firing signal parameters to compensate for these variations are explained in the following description, taken in connection with the accompanying drawings.

FIG. 1 shows a printing system having an in-line scale and configured to automatically adjust firing signal parameters to compensate for variations in drop volume in ejectors during printing.

FIG. 2 shows a side view of a printing system having a scale that is not in-line.

FIG. 3 shows a calculated relationship between drop mass and a voltage parameter for two printheads.

FIG. 4 depicts method for compensating for variations in drop volume between ejectors.

### DETAILED DESCRIPTION

For a general understanding of the environment for the device and method disclosed herein as well as the details for the apparatus and method, reference is made to the drawings. In the drawings, like reference numerals designate like elements

As used herein, the terms “electrical firing signal,” “firing signal,” and “electrical signal” are used interchangeably to refer to an electrical energy waveform that triggers an actuator in an ejector to eject a material drop. Examples of actuators in ejectors include, but are not limited to, piezoelectric, and electrostatic actuators. A piezoelectric actuator includes a piezoelectric transducer that changes shape when the firing signal is applied to the transducer. The transducer is proximate to a pressure chamber that holds material, and the change in shape of the transducer urges some of the material in the pressure chamber through an outlet nozzle in the form of a material drop that is ejected from the ejector. In some embodiments, rather than being pressurized, the pressure chamber is designed to fill through capillary action and to hold the material by vacuum. In an electrostatic actuator, the material includes electrically charged particles. The electrical firing signal generates an electrostatic charge on an actuator with the same polarity as the electrostatic charge in the material to repel material from the actuator and eject a material drop from the ejector.

As used herein, the term “peak voltage level” refers to a maximum amplitude level of an electrical firing signal. As described in more detail below, some firing signals include a waveform with both positive and negative peak voltage levels. The positive peak voltage level and negative peak voltage level in a firing signal waveform may have the same amplitude or different amplitudes. In some ejector embodiments, the peak voltage level of the firing signal affects the mass and velocity of the material drop that is ejected from the ejector in response to the firing signal. For example, higher peak voltage levels for the firing signal increase the mass and velocity of the material drop that is ejected from the ejector, while lower peak voltage levels decrease the mass and velocity of the ejected material drop. Since the object receiving surface moves in a process direction relative to the ejector at a substantially constant rate and typically remains at a fixed distance from the ejector, changes in the velocity of the ejected material drops affect the relative locations of where the material drops land on the object receiving surface in the process direction.

As used herein, the term “peak voltage duration” refers to a time duration of the peak voltage level during a firing signal. The peak voltage duration can refer to the duration of both a positive peak voltage level and negative peak voltage level in a signal. Different electrical firing signal waveforms include positive peak voltage durations and negative peak voltage durations that are either equally long or of different durations. In one embodiment, an increase in the duration of the peak voltage level in the firing signal increases the ejection velocity of the material drop while a decrease in the duration of the peak voltage level decreases the ejection velocity of the material drop. These velocity changes reduce the variation in the material drop velocities ejected by the printhead. When the material drop velocity variation is reduced, the accuracy of the material drop placement is increased.

As used herein, the term “waveform component” refers to any parameter in the shape or magnitude of an electrical firing signal waveform that is adjusted to affect the velocity of a material drop that is ejected from an ejector in response to the generation of the waveform with the adjusted component parameter. The peak voltage level and the peak voltage duration are examples of waveform components in electrical firing signals. As described below, an ejector printer adjusts one or more waveform components including either or both of the peak voltage level and peak voltage duration to adjust the ejection velocities of material drops on a drop-by-drop basis during an imaging operation. Since different drop ejection patterns result in variations of the material drop velocity due to the characteristics of the ejector and printhead, the adjustments to the waveform components enable more accurate placement of material drop patterns on the object receiving surface during the imaging operation. In some embodiments, the waveform has smaller non-firing pulses that also affect mass and velocity of a drop by changing a resonance.

The term “firing signal parameter adjustment,” as used in this document, refers to a change in a waveform component, such as, one of a peak voltage level parameter, a peak voltage duration parameter, or a frequency parameter for the firing signal. The change can be a relative increase or decrease in a peak voltage level defined for a firing signal, a relative increase or decrease in the duration of the peak voltage for the firing signal, or a relative increase or decrease in the frequency of the firing signal. Additionally, a combination of changes of two or all three parameters can be made. The firing signal parameter adjustment normalizes the material drop volumes ejected by the ejectors in the printheads so that the effective material drop volume is approximately the same for all material drops ejected by the printheads.

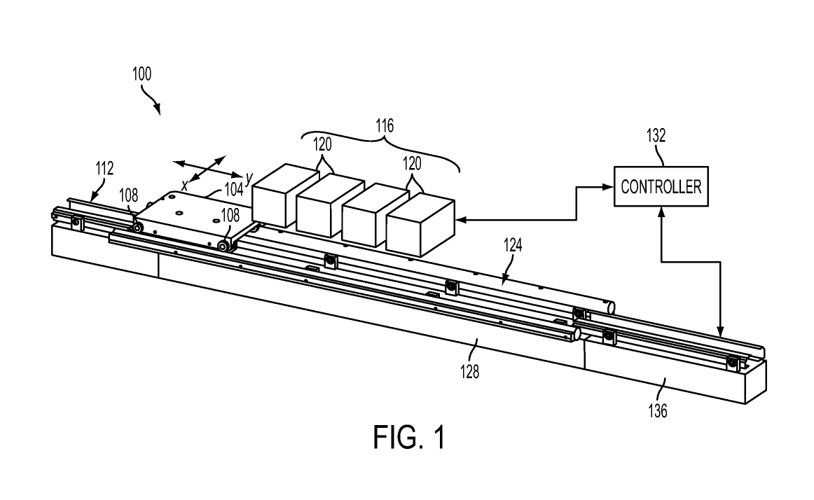

A three-dimensional object printing system 100 is shown in FIG. 1. A platform 104, called a cart, includes wheels 108 that ride upon a track 112 to enable the cart 104 to move along the track between printing stations, such as the printing station 116. The printing station 116 includes four ejector heads 120 as shown in the figure, although fewer or more ejector heads can be used in a printing station. Once the cart 104 reaches the printing station 116, the cart 104 transitions to enable wheels 108 to roll upon precision rails 124. Precision rails 124 are cylindrical rail sections that are manufactured within tight tolerances to help ensure accurate placement and maneuvering of the cart 104 beneath the ejector heads 120. Linear electrical motors are provided within housing 128 and are operatively connected to the wheels 108 of cart 104 to move the cart along the track rails 112 and to the wheels 108 to maneuver the cart 104 on the precision rails 124. Once the cart 104 is beneath the printing station 116, ejection of material occurs in synchronization with the motion of the cart. The electrical motors in housing 128 are also configured to move the cart in an X-Y plane that is parallel to the ejector heads 120 as layers of material are formed in the object. Additional motors move the printing station 116 vertically with respect to the cart 104 as layers of material accumulate to form an object. Alternatively, a mechanism can be provided to move the cart 104 vertically with respect to rails 124 as the object is formed on the top surface of the cart. Once the printing to be performed by a printing station is finished, the cart 104 is moved to another printing station for further part formation or for layer curing or other processing.

The printing system 100 further includes a controller 132 that is operably connected to the printing station 116 to operate the ejector heads 120. The controller 132 is also operably connected to a scale which is configured to measure the weight of the cart 104 or the substrate. In one embodiment, the scale 136 is built as an in-line component of the track 112, as show in FIG. 1. The scale 136 is configured to measure the weight of the cart 104 as it rests on the track 112. In one embodiment, the scale 136 is configured directly beneath the printing station 116.

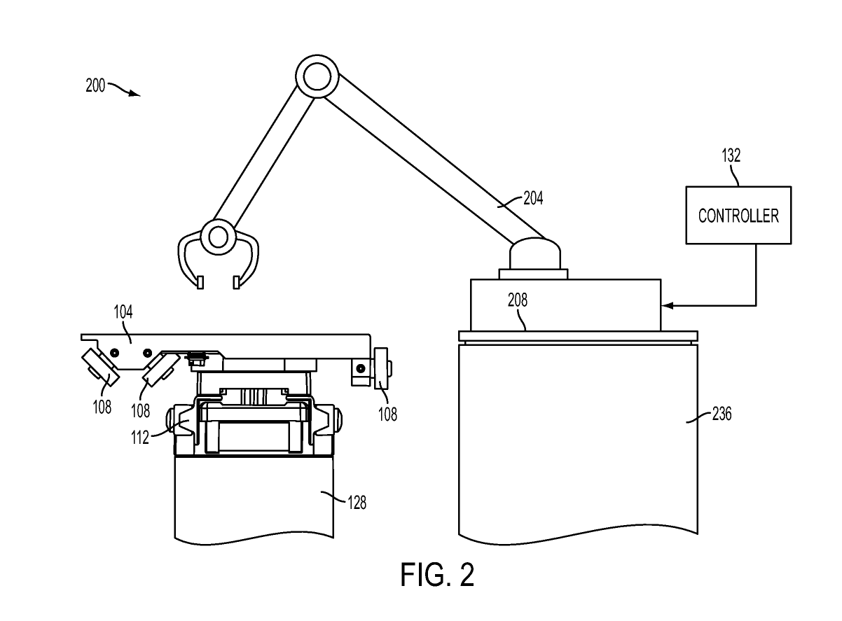

FIG. 2 shows a printing system 200, which is similar to the printing system 100, wherein a scale 236 is separate from the track 112 and configured to receive the substrate from the cart 104 and to measure the weight of the substrate directly. In this embodiment, the scale 236 includes a robotic arm 204 that enables the scale 236 to receive the substrate from the cart 104. The controller 132 controls the robotic arm 204 to grasp the substrate and to move it onto a platform 208 of the scale 236. The controller 132 controls the scale 236 to measure the weight the substrate, and then controls the robotic arm 204 to return the substrate to the cart 104. Other embodiments use other methods to move the substrate to and from the scale 236.

As noted previously, one source of error in three-dimensional object printing arises from variations in the volumes of material drops from ejector to ejector. The printing system 100 is configured to detect material drop variations between ejectors and to compensate for these variations by adjusting firing signal parameters of the ejectors. The controller 132 is configured to operate the scale 136 to take weight measurements of the cart 104 before and after the printing of a test pattern to calculate drop mass values of drops ejected by the ejectors. The controller 132 operates the scale 136 to take a first weight measurement of the cart 104, then operates the ejectors of the ejector heads 120 to eject a test pattern onto the cart 104 using a set of firing signal parameters, and then operates the scale 136 to take a second weight measurement. The controller 132 calculates a drop mass value for the ejector based on a difference between the first and second weight measurements.

The test pattern comprises a fixed number of material drops jetted onto the cart 104 using a specified pattern. In one embodiment, the test pattern comprises just one drop of material from one ejector. In this embodiment, the controller 132 determines the mass of the drop of material directly based on the difference between the first and second weight measurements. In another embodiment, the test pattern comprises several drops of material ejected from one ejector. In this embodiment, the controller 132 determines an average drop volume based on the difference between the first and second weight measurements and the number of drops ejected from the ejector. This test pattern provides increased accuracy for calibrating ejectors that produce minor variations in drop volumes from one drop to the next. In yet another embodiment, the test pattern comprises several drops ejected by several ejectors. In this embodiment, the controller 132 determines an average drop volume for the several ejectors based on the difference between the first and second weight measurements and the number of drops ejected from the ejectors. Test patterns including multiple ejectors can be used when the ejectors are expected to degrade similarly, such as ejectors of the same type or ejectors in the same ejector head.

In one embodiment, the controller 132 is configured to use many test patterns that are selectable by an operator of the printing system 100. For example, certain test patterns can be used for a more thorough high-accuracy calibration, and other test patterns can be used for a less time consuming quick calibration. In other embodiments, the controller 132 uses different test patterns based on the particular firing signal parameter being calibrated, the type of ejectors being calibrated, or the type material in the ejectors being calibrated. In some embodiments, velocity and drop mass are variable to enable an operator to calibrate for a particular job.

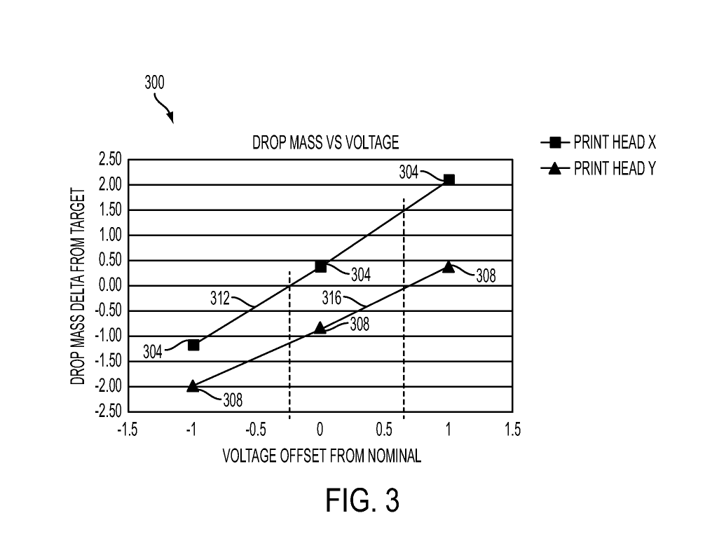

In this way, the controller 132 collects one or more drop mass values using different firing signal parameters for the ejectors. After collecting drop mass values using various firing signal parameters, the controller 132 calculates an approximate relationship between one or more of the firing signal parameters and the material drop mass for an ejector. For example, the controller 132 may calculate the relationship between a peak voltage parameter of the firing signal for a particular ejector and the drop mass ejected by the particular ejector. FIG. 3 shows a relationship between a change in voltage and a corresponding change in drop mass ejected by two printheads, X and Y. The controller 132 calculates three drop mass values 404 for printhead X, and three drop mass values 408 for printhead Y. Next, the controller 132 calculates the relationship 412 between a voltage offset from a nominal voltage for the printhead X and a change in drop mass for the printhead X. Similarly, the controller 132 calculates the relationship 316 between a voltage offset from a nominal or prior voltage for the printhead Y and a change in drop mass for the printhead Y. In other embodiments, the controller 132 is configured to determine relationships between drop mass and other firing signal parameters, such as a duration of a peak voltage parameter, a frequency parameter, and other waveform components.

In the example of FIG. 3, the controller 132 is configured to calculate the curve representing the relationship by linearly connecting each of points for the drop mass values. However, in other embodiments, the controller 132 is configured to calculate the curve using other curve-fitting methods such as linear and nonlinear regression analysis. Collecting several drop mass values is more time consuming, but enables increased accuracy in approximating the curve. However, in some embodiments, the controller 132 is configured to collect only one drop mass value for each ejector. In these embodiments, the controller 132 calculates the curve by assuming a general shape of the curve based on known characteristics of ejector degradation and performance. For example, in one embodiment, the controller 132 assumes that the curve is linear and has a particular slope that is characteristic of the type of ejector. In this way, the controller 132 uses the calculated drop mass value to determine how much the assumed curve has drifted up or down. In some embodiments, the controller 132 is configured to collect a number of drop mass values based on a selection by an operator of printing system 100. In other embodiments, the controller 132 is configured to collect a number of drop mass values based on the particular firing signal parameter being calibrated, the type of ejectors being calibrated, or the type material in the ejectors being calibrated.

After the controller 132 approximates one or more curves representing relationships between drop mass and various firing signal parameters for one or more ejectors of the ejector heads 120, the controller 132 is configured to adjust the nominal firing signal parameters for the ejectors so that each of the ejectors ejects drops of material having about the same volume or mass. To accomplish this, the controller 132 uses the calculated curves to interpolate values for the firing signal parameters of each ejector such that the ejectors eject drops of material having an ideal or target volume. In the example of FIG. 3, the controller 132 calculates that the voltage for printhead X should be decreased by 0.3 volts and that the voltage for printhead Y should be increased by 0.7 volts. In this way, the controller 132 calibrates each of the ejectors to compensate for volumetric drop variations in the ejectors during printing.

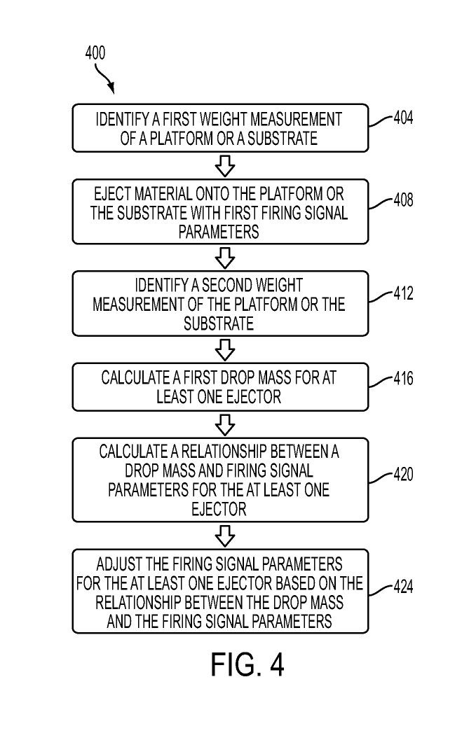

A method 400 for operating a printing system to compensate for volumetric drop variations in ejectors during printing is shown in FIG. 4. In the description of the method, statements that the method is performing some task or function refers to a controller or general purpose processor executing programmed instructions stored in non-transitory computer readable storage media operatively connected to the controller or processor to manipulate data or to operate one or more components in the printer to perform the task or function. The controller 132 noted above can be such a controller or processor. Alternatively, the controller can be implemented with more than one processor and associated circuitry and components, each of which is configured to form one or more tasks or functions described herein.

When the method 400 is performed, it begins by identifying a first weight measurement of a platform or substrate (block 404). The controller 132 operates the scale 136 to identify a first weight measurement of the cart 104. Alternatively, in the case of a scale that is not built into the track 112, the controller 132 operates the scale to receive the substrate from the cart and to identify a first weight measurement of the substrate. In one embodiment, the controller 132 is configured to tare the scale with the weight of the cart 104 or the substrate. Next, the method 400 ejects material onto the platform or the substrate with first firing signals (block 408). The controller 132 operates the ejectors of the ejector heads 120 to eject drops of material corresponding to a test pattern onto the cart 104 or the substrate. Next, the method 400 identifies a second weight measurement of the cart 104 or the substrate (block 412). The controller operates the scale 136 to identify a second weight measurement of the cart 104 or the substrate. Next, the method 400 calculates a first drop mass for at least one ejector (block 416). The controller 132 calculates a first drop mass for at least one ejector based on a difference between the identified first and second weight measurements. In the case of a test pattern having several drops ejected from the at least one ejector, the controller 132 calculates an average first drop mass based on the difference between the first and second weight measurements and the number of drops ejected by the at least one ejector. The portion of the method depicted in blocks 404, 408, 412, and 416 are optionally repeated to collect several drop mass values using different firing signal parameters.

Next, the method 400 calculates a relationship between a drop mass and firing signal parameters for the at least one ejector (block 420). The controller 132 calculates a relationship between the drop mass and a firing signal parameter for at least one ejector based on the collected drop mass values, at least including the first drop mass. The controller 132 is configured to approximate a curve that fits the collected drop mass values using a curve fitting method. Next, the method 400 adjusts the firing signal parameters for the at least one ejector based on the relationship between the drop mass and the firing signal parameters (block 424). The controller uses the calculated relationship to interpolate a value for the firing signal parameter that is expected to cause the at least one ejector to eject a drop of material having an ideal or target volume. The controller 132 sets this value as the new nominal firing signal parameter for the at least one ejector, thereby compensating for variations in the drop volume of the at least one ejector compared with other ejectors of the printing station 116

In one embodiment, the controller 132 is configured to periodically perform the method 400 automatically at predetermined times or after a predetermined number of printing operations. In other embodiments, the controller 132 is configured to perform the method 400 at the command of an operator of the printing system 100. In some embodiments, the cart 104 must be cleaned or otherwise prepared to accept a large volume of uncured material before performing the method 400. Additionally, in some embodiments, the height of the ejector heads 120 of the printing station 116 must be appropriately adjusted before performing the method 400. In one embodiment, the controller 132 is configured to automatically perform this preliminary setup.

The method 400 for calibrating ejectors to compensate for drop variations between ejectors can be augmented by performing small automatic firing signal adjustments between executions of the method 400. For example, small adjustments to a peak voltage parameter can automatically be made based on an expected degradation curve, or “drift curve.” These small adjustments can help to ensure continued robust performance between calibrations.

It will be appreciated that variants of the above-disclosed and other features and functions, or alternatives thereof, may be desirably combined into many other different systems, applications or methods. Various presently unforeseen or unanticipated alternatives, modifications, variations, or improvements therein may be subsequently made by those skilled in the art, which are also intended to be encompassed by the following claims.

What is claimed is:

1. A three-dimensional object printer comprising:
a track;
at least one ejector head disposed along the track, the at least one ejector head being configured to eject drops of a material onto a substrate;
a platform configured to move along the track to convey the substrate to a position to enable the at least one ejector head to eject drops of the material onto the substrate;
a scale configured to measure a weight of at least one of the platform and the substrate; and
a controller operatively connected to the scale and the at least one ejector head, the controller being configured to:
operate the scale to identify a first weight measurement of at least one of the platform and the substrate;
operate the at least one ejector head with first firing signal parameters to eject material onto the at least one of the platform and the substrate;
operate the scale to identify a second weight measurement of the least one of the platform and the substrate;
calculate a first drop mass of at least one ejector in the at least one ejector head based on a difference between the first weight measurement and the second weight measurement;
calculate a relationship between a drop mass of the at least one ejector and firing signal parameters for the at least one ejector based on the calculated first drop mass; and
adjust the firing signal parameters for the at least one ejector based on the calculated relationship between the drop mass of the at least one ejector and the firing signal parameters for the at least one ejector to compensate for variations in drop volumes between the at least one ejector and other ejectors in the at least one ejector head.

2. The printer of claim 1, the scale being further configured to identify the first weight measurement of the platform and the second weight measurement of the platform while the platform is positioned on the track.

3. The printer of claim 1, the scale being further configured to receive the substrate from the platform and to identify the first weight measurement of the substrate and the second weight measurement of the substrate.

4. The printer of claim 1, the controller being further configured to:
operate the at least one ejector head with second firing signal parameters to eject material on the at least one of the platform and the substrate;
operate the scale to identify a third weight measurement of the at least one of the platform and the substrate;
calculate a second drop mass of the at least one ejector based on a difference between the second weight measurement and the third weight measurement; and
calculate the relationship between the drop mass of the at least one ejector and the firing signal parameters for the at least one ejector based on the calculated first drop mass and the calculated second drop mass.

5. The printer of claim 1, the controller being further configured to:
calculate a relationship between the drop mass of the at least one ejector and a peak voltage parameter for the at least one ejector based on the calculated first drop mass.

6. The printer of claim 5, the controller being further configured to:
adjust the firing signal parameters for the at least one ejector by modifying the peak voltage parameter of the at least one ejector based on the calculated relationship between the drop mass of the at least one ejector and the peak voltage parameter for the at least one ejector.

7. The printer of claim 1, the controller being further configured to:
calculate a relationship between the drop mass of the at least one ejector and a duration of a peak voltage parameter for the at least one ejector based on the calculated first drop mass.

8. The printer of claim 7, the controller being further configured to:
adjust the firing signal parameters for the at least one ejector by modifying the duration of the peak voltage parameter of the at least one ejector based on the calculated relationship between the drop mass of the at least one ejector and the duration of the peak voltage parameter for the at least one ejector.

9. The printer of claim 1, the controller being further configured to:
calculate a relationship between the drop mass of the at least one ejector and a frequency parameter for the at least one ejector based on the calculated first drop mass.

10. The printer of claim 9, the controller being further configured to:
adjust the firing signal parameters for the at least one ejector by modifying the frequency parameter of the at least one ejector based on the calculated relationship between the drop mass of the at least one ejector and the frequency parameter for the at least one ejector.

11. A method of operating a three-dimensional object printer comprising:
operating a scale to identify a first weight measurement of at least one of a platform and a substrate;
operating an at least one ejector head with first firing signal parameters to eject material onto the at least one of the platform and the substrate;
operating the scale to identify a second weight measurement of the least one of the platform and the substrate;
calculating a first drop mass of at least one ejector in the at least one ejector head based on a difference between the first weight measurement and the second weight measurement;
calculating a relationship between a drop mass of the at least one ejector and firing signal parameters for the at least one ejector based on the calculated first drop mass; and
adjusting the firing signal parameters for the at least one ejector based the calculated relationship between the drop mass of the at least one ejector and the firing signal parameters for the at least one ejector to compensate for variations in drop volumes between the at least one ejector and other ejectors in the at least one ejector head.

12. The method of claim 11, the operating of the scale to identify the first weight measurement further comprising:
identifying the first weight measurement of the platform.

13. The method of claim 11, the operating of the scale to identify the first weight measurement further comprising:
receiving the substrate from the platform; and
identifying the first weight measurement of the substrate.

14. The method of claim 11 further comprising:
operating the at least one ejector head with second firing signal parameters to eject material on the at least one of the platform and the substrate;
operating the scale to identify a third weight measurement of the at least one of the platform and the substrate;
calculating a second drop mass of the at least one ejector based on a difference between the second weight measurement and the third weight measurement; and
calculating the relationship between the drop mass of the at least one ejector and the firing signal parameters for the at least one ejector based on the calculated first drop mass and the calculated second drop mass.

15. The method of claim 11, the calculating of the relationship further comprising:
calculating a relationship between the drop mass of the at least one ejector and a peak voltage parameter for the at least one ejector based on the calculated first drop mass.

16. The method of claim 15, the adjustment of the firing signal parameters further comprising:
adjusting the firing signal parameters of the at least one ejector by modifying the peak voltage parameter of the at least one ejector based on the calculated relationship between the drop mass of the at least one ejector and the peak voltage parameter for the at least one ejector.

17. The method of claim 11, the calculating of the relationship further comprising:
calculating a relationship between the drop mass of the at least one ejector and a duration of a peak voltage parameter for the at least one ejector based on the calculated first drop mass.

18. The method of claim 17, the adjustment of the firing signal parameters further comprising:
adjusting the firing signal parameters of the at least one ejector by modifying the duration of the peak voltage parameter of the at least one ejector based on the relationship between the drop mass of the at least one ejector and the duration of the peak voltage parameter for the at least one ejector.

19. The method of claim 11, the calculating of the relationship further comprising:
calculating a relationship between the drop mass of the at least one ejector and a frequency parameter for the at least one ejector based on the calculated first drop mass.

20. The method of claim 19, the adjustment of the firing signal parameters further comprising:
adjusting the firing signal parameters of the at least one ejector by modifying the frequency parameter of the at least one ejector based on the relationship between the drop mass of the at least one ejector and the frequency parameter for the at least one ejector.
